(19) United States
(12) Patent Application Publication
(10) Pub. No.: US 2017/0104932 A1
(43) Pub. Date: Apr. 13, 2017

(54) CORRECTION METHOD AND ELECTRONIC DEVICE

(71) Applicant: FUJITSU LIMITED, Kawasaki-shi (JP)

(72) Inventors: Shan Jiang, Zama (JP); Keiju Okabayashi, Sagamihara (JP)

(73) Assignee: FUJITSU LIMITED, Kawasaki-shi (JP)

(21) Appl. No.: 15/285,832

(22) Filed: Oct. 5, 2016

(30) Foreign Application Priority Data
Oct. 9, 2015 (JP) 2015-201496

(51) Int. Cl. H04N 5/232

(52) U.S. Cl. CPC H04N 5/23258; H04N 5/23229

(57) ABSTRACT

An electronic device includes a camera configured to capture a plurality of images according to an imaging time based on a first dock, a sensor configured to measure a parameter for determining an attitude according to a measurement time based on a second dock, and circuitry. The circuitry determines an attitude of the camera, determine an attitude of the sensor, calculates a rotation parameter indicating a difference between the attitude of the camera and the attitude of the sensor in a first measurement time period during which the attitude of the electronic device is in a stable state, corrects at least one of the attitude of the camera and the attitude of the sensor, calculate a time difference between a first time measured by the first clock and a second time measured by the second dock, and corrects at least one of the imaging time and the measurement time.

### CROSS-REFERENCE TO RELATED APPLICATION

This application is based upon and claims the benefit of priority of the prior Japanese Patent Application No. 2015-201496, filed on Oct. 9, 2015, the entire contents of which are incorporated herein by reference.

### FIELD

The embodiments discussed herein are related to a calibration technique in an electronic device.

### BACKGROUND

Some recent mobile phone terminals include inertial sensors. The inertial sensors are used to, for example, determine attitudes of the mobile phone terminals. When the mobile phone terminals further include cameras, the cameras and the inertial sensors are assumed to be used in combination.

For example, related techniques are described in Japanese Laid-open Patent Publication Nos. 2000-97637 and 2011-220811, and Japanese National Publication of International Patent Application No. 2014-526736.

### SUMMARY

According to an aspect of the invention, an electronic device includes a camera configured to capture a plurality of images according to an imaging time based on a first clock, a sensor configured to measure a parameter for determining an attitude of the sensor according to a measurement time based on a second clock, and circuitry. The circuitry is configured to determine an attitude of the camera based on the plurality of images captured by the camera, determine an attitude of the sensor based on a plurality of parameters measured by the sensor, first calculate a rotation parameter indicating a difference between the attitude of the camera and the attitude of the sensor based on the attitude of the sensor and the attitude of the camera in a first measurement time period during which the attitude of the electronic device is in a stable state, first correct at least one of data indicating the attitude of the camera and data indicating the attitude of the sensor based on the rotation parameter, second calculate a time difference between a first time measured by the first clock and a second time measured by the second clock based on the attitude of the camera and the attitude of the sensor in a second measurement time period, and second correct at least one of the imaging time and the measurement time based on the time difference.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration example of a mobile device;

FIG. 2 is a view for explaining an outline of coordinate systems;

FIG. 3 is a view for explaining determination of an attitude by means of imaging a marker;

FIG. 4 is a view for explaining calculation of a difference time;

FIG. 5 is a view illustrating relationships between a coordinate system of an inertial sensor and a vertical line;

FIG. 6 is a view for explaining a way of handling the mobile device in adjustment;

FIG. 7 is a graph depicting a difference between an imaging time and a measurement time;

FIG. 8 is a diagram depicting a module configuration example of the mobile device;

FIG. 9 is view depicting a main process flow;

FIG. 10 is a view depicting a camera process (A) flow;

FIG. 11 is a view depicting a configuration example of a first attitude table;

FIG. 12 is a view depicting an inertial sensor process (A) flow;

FIG. 13 is a view depicting a configuration example of measurement data;

FIG. 14 is a view depicting a configuration example of a second attitude table;

FIG. 15 is a view depicting a first determination process flow;

FIG. 16 is a view depicting a first calculation process flow;

FIG. 17 is a view depicting a second determination process flow;

FIG. 18 is a view depicting a second calculation process flow;

FIG. 19 is a view depicting a judgment process flow;

FIG. 20 is a view depicting a camera process (B) flow; and

FIG. 21 is a view depicting an inertial sensor process (B) flow.

### DESCRIPTION OF EMBODIMENTS

When a camera and an inertial sensor are used together, it is desirable that an imaging time of the camera and a measurement time of the inertial sensor are aligned with each other. Moreover, it is convenient when a coordinate system of the camera and a coordinate system of the inertial sensor are aligned with each other.

However, when a clock for determining the imaging time of the camera and a clock for determining the measurement time of the inertial sensor are separately provided, a time error occurs in some cases. Moreover, depending on installed states of the camera and the inertial sensor, the coordinate systems may not be aligned with each other.

Generally, it is sometimes difficult to adjust one of errors caused by hardware by focusing only on this error to capture and correct this error by software.

An object of a technique disclosed in the embodiments is to efficiently reduce the time error and the attitude error concerning the camera and the sensor configured to determine the attitude which are included in the same electronic device.

### Embodiment 1

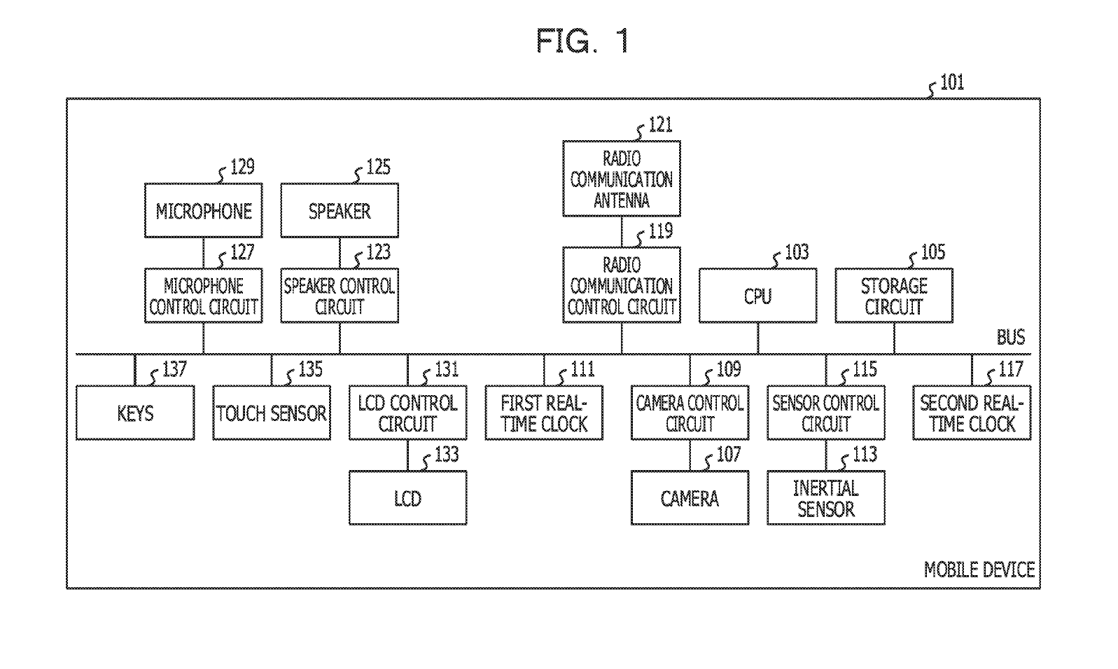

FIG. 1 illustrates a hardware configuration example of a mobile device 101. The mobile device 101 includes a central processing unit (CPU) 103, a storage circuit 105, a camera 107, a camera control circuit 109, a first real-time clock 111, an inertial sensor 113, a sensor control circuit 115, a second real-time clock 117, a radio communication control circuit 119, a radio communication antenna 121, a speaker control circuit 123, a speaker 125, a microphone control circuit 127, a microphone 129, a liquid crystal display (LCD) control circuit 131, a LCD 133, a touch sensor 135, and keys 137. The CPU 103, the storage circuit 105, the camera control circuit 109, the sensor control circuit 115, the radio communication control circuit 119, the speaker control circuit 123, the microphone control circuit 127, the LCD control circuit 131, the touch sensor 135, and the keys 137 are connected to a bus.

The CPU 103 performs computation processes. The CPU 103 has, for example, a read-only memory (ROM), a random-access memory (RAM), and a flash memory. The ROM stores preset data and underlying programs. The RAM includes a region in which the programs are developed. The RAM also includes a region in which data is temporarily stored. The flash memory stores, for example, application programs and data to be held.

The camera control circuit 109 controls the camera 107. Moreover, the camera control circuit 109 determines an imaging time based on a time obtained from the first real-time clock 111.

The sensor control circuit 115 controls the inertial sensor 113. Moreover, the sensor control circuit 115 determines a measurement time based on a time obtained from the second real-time clock 117. The inertial sensor 113 measures angular velocities (or angles) relating to the attitude of itself and acceleration relating to the movement of itself. In this example, the inertial sensor 113 includes a three-axis gyro sensor and a three-direction acceleration sensor. Note that the three axes of the gyro sensor and the three directions of the acceleration sensor are aligned with one another,

The radio communication antenna 121 receives radio data such as cellular data, wireless local area network (LAN) data, and near field communication data. The radio communication control circuit 119 controls radio communication. Audio communication of phone and data communication of mails are performed by controlling the radio communication.

The speaker control circuit 123 performs digital-to-analog conversion relating to audio data. The speaker 125 outputs analog data as sounds. The microphone control circuit 127 performs analog-to-digital conversion relating to audio data. The microphone 129 converts sounds to analog data.

The LCD control circuit 131 drives the LCD 133. The LCD 133 displays a screen. The touch sensor 135 is, for example, a panel-shaped sensor disposed on a display surface of the LCD 133 and receives instructions made by touch operations. Specifically, the LCD 133 and the touch sensor 135 are used integrally as a touch panel. The keys 137 are provided in one portion of a case.

The time obtained from the first real-time clock 111 and the time obtained from the second real-time clock 117 are not aligned with each other in some cases. Accordingly, in the embodiment, correction is made to approximate the imaging time and the measurement time.

Note that the mobile device 101 illustrated in FIG. 1 is a mobile phone (including a feature phone and a smartphone) and is an example of a mobile electronic device. However, the embodiment may be applied to other electronic devices. For example, a module similar to the mobile device 101 may be provided in electronic devices such as wrist-watch-type and head-mounted-type wearable terminals, tablet terminals, game consoles, pedometers, sound recorders, music players, digital camera devices, image reproducing devices, television sets, radio receivers, controllers, electronic clocks, electronic dictionaries, electronic translators, transceivers, GPS transmitters, measurement devices, health support devices, and medical devices, and execute processes to be described below.

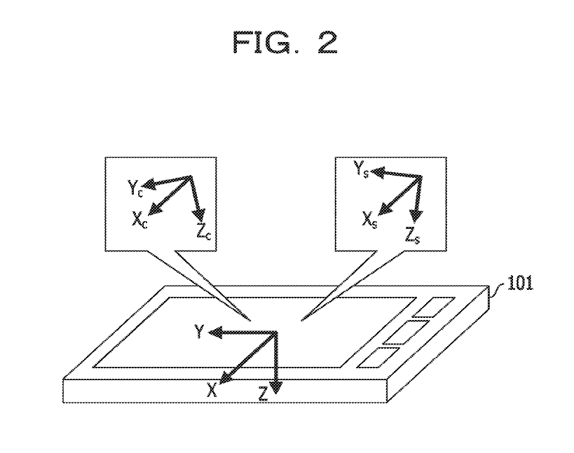

Next, an outline of a coordinate system in the mobile device 101 is described by using FIG. 2. In this example, in the coordinate system of the mobile device 101, an X-axis is provided in a horizontal direction, a Y-axis is provided in a vertical direction, and a Z-axis is provided in a direction perpendicular to a back surface. Note that a coordinate system (X_{c}, Y_{c}, Z_{c}) of the camera 107 is sometimes offset from the coordinate system (X, Y, Z) of the mobile device 101. Moreover, a coordinate system (Xₛ, Yₛ, Z₅) of the inertial sensor 113 is sometimes offset from the coordinate system (X, Y, Z) of the mobile device 101. Specifically, the coordinate system (X_{c}, Y_{c}, Z_{c}) of the camera 107 and the coordinate system (Xₛ, Yₛ, Zₛ) of the inertial sensor 113 do not have to be aligned with each other. Accordingly, in the embodiment, correction is performed to approximate the coordinate system of the camera 107 and the coordinate system of the inertial sensor 113 to each other. In the following description, the coordinate system of the camera 107 is referred to as camera coordinate system, and the coordinate system of the inertial sensor 113 is referred to as sensor coordinate system.

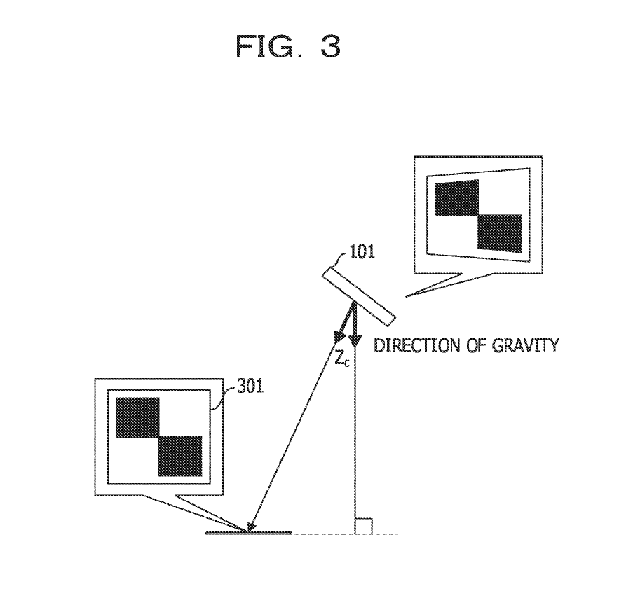

In the embodiment, the attitude of the camera 107 is estimated by imaging a marker. The estimation of the attitude by imaging the marker is described by using FIG. 3. A marker 301 is a predetermined pattern. Moreover, in this example, the marker 301 is arranged horizontally.

Based on the shapes of a portion corresponding to the marker 301 included in an image captured by the camera 107, the mobile device 101 estimates the position and attitude of the mobile device 101 relative to the marker 301. Furthermore, the mobile device 101 determines the direction of gravity in the camera coordinate system. A line extending from an original point of the coordinate system of the camera 107 and being perpendicular to a surface on which the marker 301 is arranged corresponds to a vertical line. Accordingly, the direction of gravity is determined by obtaining the vertical line.

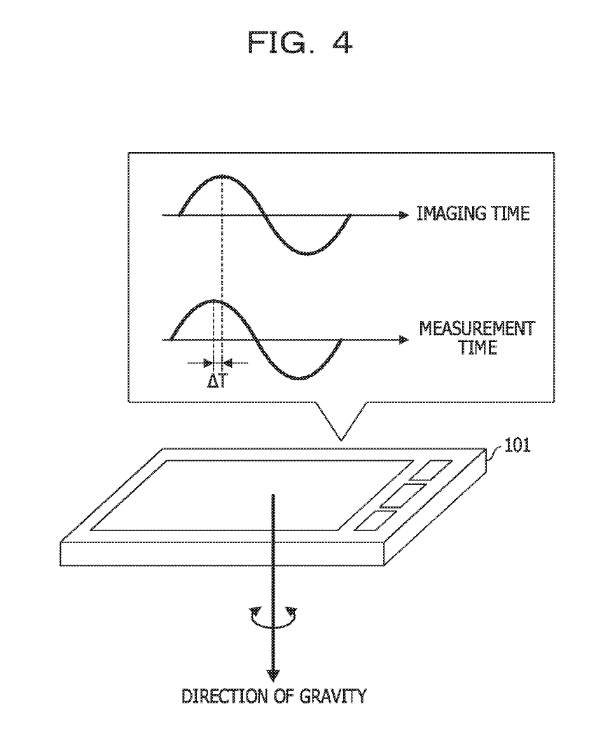

In the embodiment, a difference time between the imaging time and the measurement time is calculated based on attitude data detected during rotation of the mobile device 101. The calculation of the difference time is described by using FIG. 4. A user directs an optical axis of the camera 107 toward the marker 301. Then, the user rotates the mobile device 101 about the optical axis of the camera 107 such that the display surface of the mobile device 101 are not moved upward or downward. In this example, the user handles the mobile device 101 such that the mobile device 101 is turned rightward and leftward. The mobile device 101 is rotated 90 degrees in one direction, thereafter rotated 180 degrees in the reverse direction, and then rotated 90 degrees in the original direction to return to the original state. Note that the angle of rotation may be any angle. For example, the mobile device 101 may be rotated 360 degrees in one direction.

The attitude of the camera 107 is estimated based on the shapes of the portion corresponding to the marker 301 included in the images captured during this rotation. Hereafter, the attitude of the camera 107 determined based on the shapes of the portion corresponding to the marker 301 included in the captured image is referred to as first attitude. The upper graph depicted in FIG. 4 schematically depicts relationships between the imaging time and the first attitude.

Furthermore, the attitude of the inertial sensor 113 is determined based on data measured by the inertial sensor 113 during this rotation. Hereafter, the attitude of the inertial sensor 113 determined based on the data measured by the inertial sensor 113 is referred to as second attitude. The lower graph depicted in FIG. 4 schematically depicts relationships between the measurement time and the second attitude.

The mobile device 101 calculates a difference between the imaging time and the measurement time, that is the difference time ΔT, under the assumption that the first attitude and the second attitude are similar to each other. Thereafter, the imaging time or the measurement time is corrected based on the calculated difference time ΔT. In the embodiment, the imaging time is corrected. Note that an example in which the measurement time is corrected is explained in an embodiment to be described later. An error in the first attitude and the second attitude affects the accuracy of the difference time ΔT.

The error in the first attitude and the second attitude corresponds to a difference between the camera coordinate system and the sensor coordinate system. In the embodiment, the difference is obtained based on the aforementioned direction of gravity in the camera coordinate system and a direction of gravity in the sensor coordinate system. The direction of gravity is thus determined also in the sensor coordinate system.

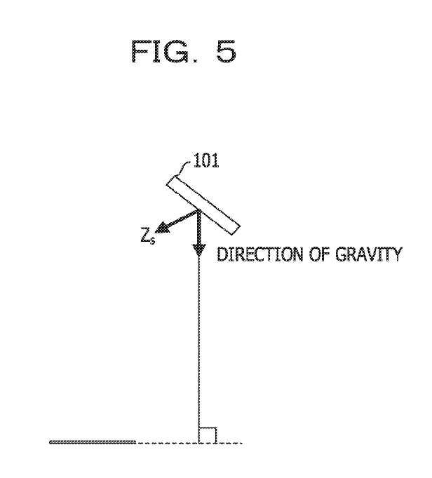

FIG. 5 illustrates a relationship between the sensor coordinate system and the vertical line. In the embodiment, the direction of gravity in the sensor coordinate system is determined by separating a gravity component from acceleration measured by the inertial sensor 113. Then, the camera coordinate system and the sensor coordinate system are compared with each other with the mobile device 101 set in a stationary state.

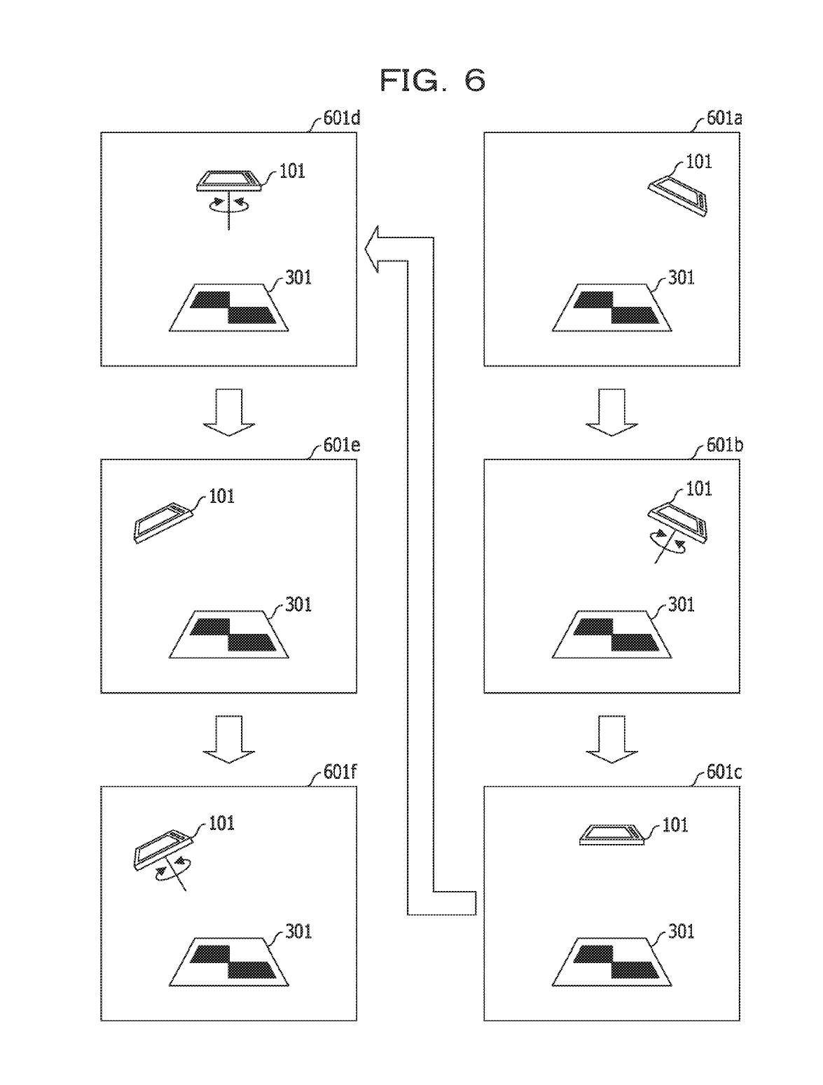

Next, a way of handling the mobile device 101 in the adjustment is described. The user is assumed to handle the mobile device 101 as illustrated in, for example, FIG. 6.

FIG. 6 illustrates the way of handling the mobile device 101 in the order of a frame 601a to a frame 601f. First, as illustrated in the frame 601a, the user holds the mobile device 101 still at a position where the mobile device 101 images the marker 301 from an upper right side. Then, as illustrated in the frame 601b, the user rotates the mobile device 101 at the same position as that in the frame 601a.

Next, the user moves the mobile device 101 to a position where the mobile device 101 images the marker 301 from above. As illustrated in the frame 601c, the user holds the mobile device 101 still at that position. Then, as illustrated in the frame 601d, the user rotates the mobile device 101 at the same position as that in the frame 601c.

Next, the user moves the mobile device 101 to a position where the mobile device 101 images the marker 301 from an upper left side. As illustrated in the frame 601e, the user holds the mobile device 101 still at that position. Then, as illustrated in the frame 601f, the user rotates the mobile device 101 at the same position as that in the frame 601e.

In the following description, a period in which the mobile device 101 is continuously held still is referred to as stationary period. Moreover, a period in which an operation of rotating the mobile device 101 is performed is referred to as rotation period.

A first rotation matrix is obtained based on the first attitude and the second attitude obtained in the stationary period illustrated in the frame 601a. Moreover, a first difference time is obtained based on the first attitude and the second attitude obtained in the rotation period illustrated in the frame 601b.

Then, a second rotation matrix is obtained based on the first attitude and the second attitude obtained in the stationary period illustrated in the frame 601c. Moreover, a second difference time is obtained based on the first attitude and the second attitude obtained in the rotation period illustrated in the frame 601d.

Then, a third rotation matrix is obtained based on the first attitude and the second attitude obtained in the stationary period illustrated in the frame 601e. Moreover, a third difference time is obtained based on the first attitude and the second attitude obtained in the rotation period illustrated in the frame 601f.

As described above, performing the adjustment in multiple poses has a characteristic that calibration accuracy tends to be stable. Moreover, since the correction on the time error and the correction on the attitude error are reflected every time the adjustment is performed, performing the adjustment in multiple poses has a characteristic that the time error and the attitude error tend to converge. Note that, although the example in which the mobile device 101 is held still and then rotated at the same position is described in FIG. 6, the order of these operations may be reversed. Specifically, the mobile device 101 may be rotated and then held still at the same position. Moreover, the position at which the mobile device 101 is held still and the position at which the mobile device 101 is rotated do not have to be aligned.

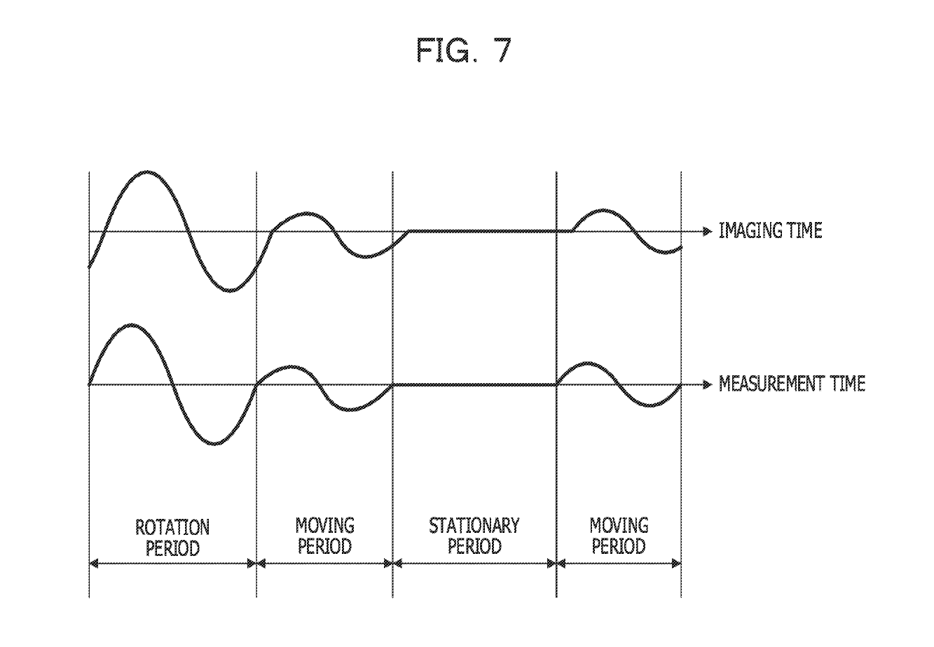

Next, relationships between the time error and the attitude error are described. The upper graph in FIG. 7 schematically depicts a change of the first attitude. The horizontal axis represents the imaging time. Similarly, the lower graph schematically depicts a change of the second attitude. The horizontal axis represents the measurement time.

In FIG. 7, the changes of the attitudes in the rotation period are depicted by large sine waves for the sake of convenience. Attitude angles in the rotation periods may not change in this way. Moreover, the changes of the attitudes in periods in which the mobile device 101 are moved (hereafter, referred to as moving periods) are similarly depicted by small sine waves for the sake of convenience. The attitude angles in the moving periods may not change in this way. Furthermore, the attitudes in the stationary period are 0 for the sake of convenience. The attitude angles in the stationary period may not be like this.

Moreover, the waveform indicating the change of the first attitude and the waveform indicating the change of the second attitude may not be the same. However, the waveform indicating the change of the first attitude and the waveform indicating the change of the second attitude are assumed to be similar to each other to a certain extent.

In this example, the imaging time precedes the measurement time. Specifically, the time measured by the first real-time clock 111 is faster than the time measured by the second real-time clock 117. Accordingly, the waveform of the upper graph is shifted to the right side as a whole compared to the waveform of the lower graph,

In this example, the rotation period and the stationary period are determined based on the second attitude. Accordingly, the rotation period and the stationary period are determined to be measurement time slots.

Meanwhile, an imaging time slot which substantially corresponds to the rotation period is faster than the measurement time slot for determining the rotation period. Similarly, an imaging time slot which substantially corresponds to the stationary period is faster than the measurement time slot for determining the stationary period.

A difference between the waveform indicating the change of the first attitude and the waveform indicating the change of the second attitude, that is the difference time between the imaging time and the measurement time corresponds to an error between the time measured by the first real-time clock 111 and the time measured by the second real-time clock 117. In the embodiment, the difference time in the rotation period is obtained to correct the difference between the imaging time and the measurement time.

If calibration of the attitude error is performed with the time error being disregarded, effects of the time error remain and the attitude error is less likely to converge in the course of adjustment. Meanwhile, if calibration of the time error is performed with the attitude error being disregarded, effects of the attitude error remain and the time error is less likely to converge in the course of adjustment. In the embodiment, since the adjustment for the attitude error and the adjustment for the time error are alternately repeated, calibration accuracy is improved in both adjustments by interaction therebetween. The description of the outline of the embodiment is completed.

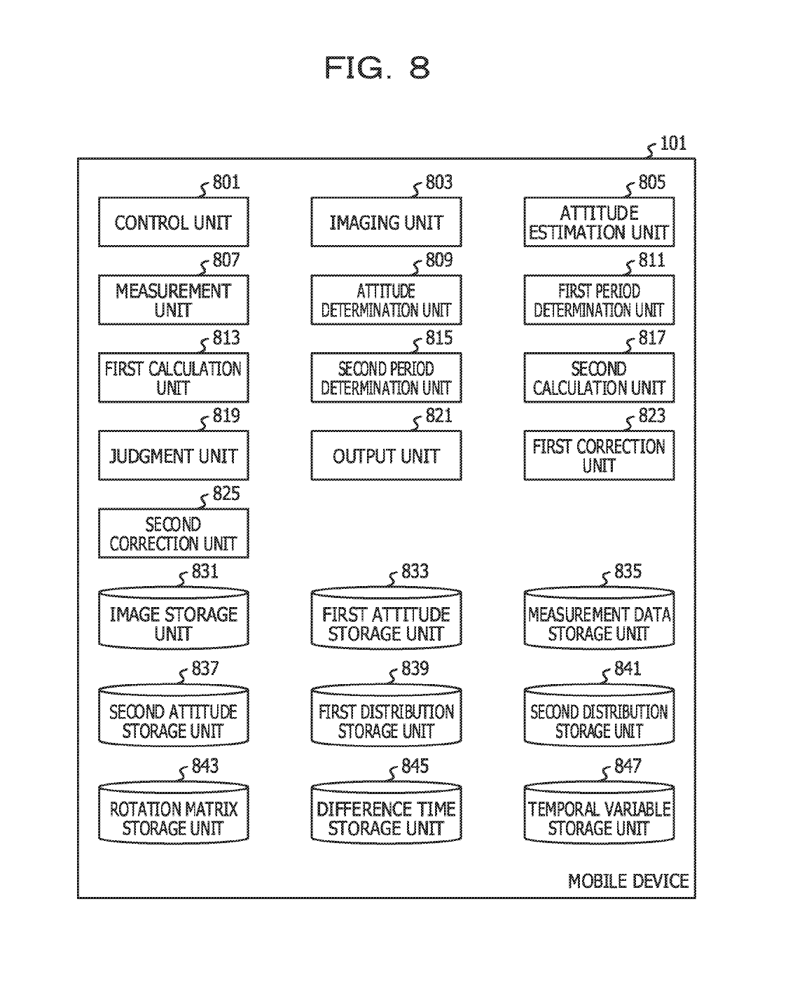

Next, operations of the mobile device 101 are described. FIG. 8 illustrates an module configuration example of the mobile device 101. The mobile device 101 includes a control unit 801, an imaging unit 803, an attitude estimation unit 805, a measurement unit 807, an attitude determination unit 809, a first period determination unit 811, a first calculation unit 813, a second period determination unit 815, a second calculation unit 817, a judgment unit 819, an output unit 821, a first correction unit 823, a second correction unit 825, an image storage unit 831, a first attitude storage unit 833, a measurement data storage unit 835, a second attitude storage unit 837, a first distribution storage unit 839, a second distribution storage unit 841, a rotation matrix storage unit 843, a difference time storage unit 845, and a temporal variable storage unit 847.

The control unit 801 controls start and stop of a camera process. Moreover, the control unit 801 controls start and stop of an inertial sensor process. The control unit 801 also controls a repeat process. The imaging unit 803 periodically performs imaging with the camera 107. The attitude estimation unit 805 estimates the first attitude. The measurement unit 807 periodically performs measurement with the inertial sensor 113. The attitude determination unit 809 determines the second attitude. The first period determination unit 811 determines the stationary period by using the measurement time slot. The first calculation unit 813 calculates a rotation matrix used to perform conversion of approximating the camera coordinate system to the sensor coordinate system. In an embodiment to be described later, the first calculation unit 813 calculates a rotation matrix used to perform conversion of approximating the sensor coordinate system to the camera coordinate system. The second period determination unit 815 determines the rotation period by using the measurement time slot. The second calculation unit 817 calculates the difference time between the imaging time and the measurement time. The judgment unit 819 determines whether the rotation matrix and the difference time are converged. The output unit 821 outputs a signal indicating completion of the adjustment. The first correction unit 823 corrects the first attitude based on the rotation matrix. Note that, in the other embodiment, the first correction unit 823 corrects the second attitude based on the rotation matrix. The second correction unit 825 corrects the imaging time based on the difference time. Note that, in the other embodiment, the second correction unit 825 corrects the measurement time based on the difference time,

The image storage unit 831 stores the images captured by the camera 107. The first attitude storage unit 833 stores the first attitude in association with the imaging time. The measurement data storage unit 835 stores the measurement results of the inertial sensor 113. The second attitude storage unit 837 stores the second attitude in association with the measurement time. The first distribution storage unit 839 stores distribution of vectors in the direction of gravity in the camera coordinate system. The second distribution storage unit 841 stores distribution of vectors in the direction of gravity in the sensor coordinate system. The rotation matrix storage unit 843 stores the rotation matrix. The difference time storage unit 845 stores the difference time. The temporal variable storage unit 847 stores values of variables temporarily used in the processes.

The control unit 801, the imaging unit 803, the attitude estimation unit 805, the measurement unit 807, the attitude determination unit 809, the first period determination unit 811, the first calculation unit 813, the second period determination unit 815, the second calculation unit 817, the judgment unit 819, the output unit 821, the first correction unit 823, and the second correction unit 825 which are described above are implemented by using hardware resources (for example, FIG. 1) and programs which cause a processor to perform processes described below.

The image storage unit 831, the first attitude storage unit 833, the measurement data storage unit 835, the second attitude storage unit 837, the first distribution storage unit 839, the second distribution storage unit 841, the rotation matrix storage unit 843, the difference time storage unit 845, and the temporal variable storage unit 847 which are described above are implemented by using the hardware resources (for example, FIG. 1).

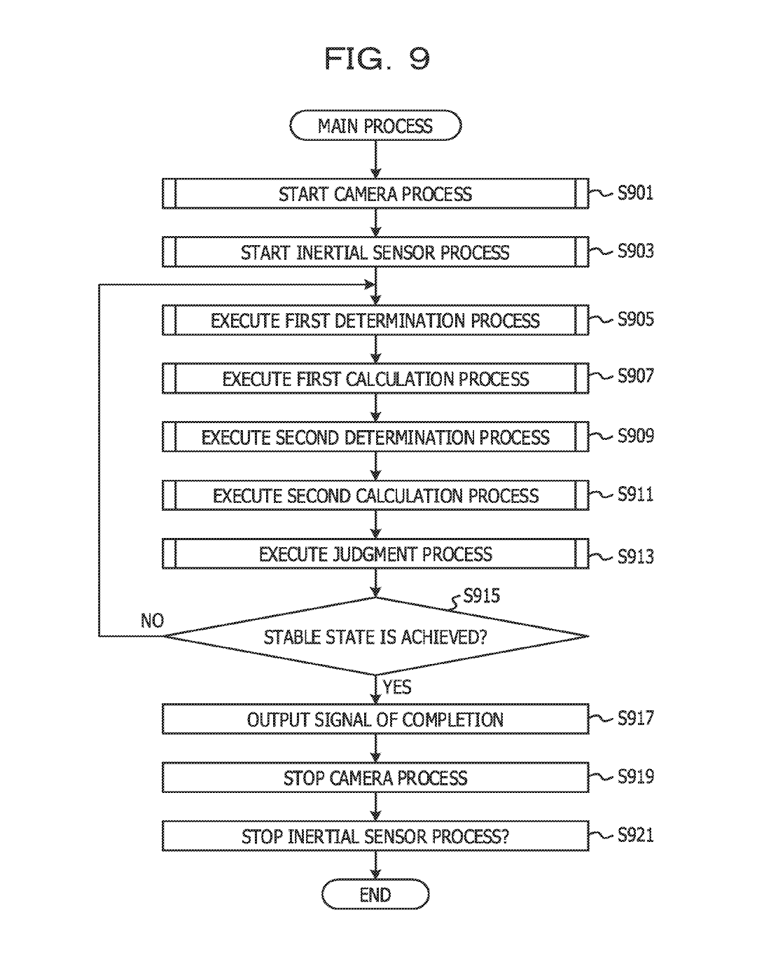

FIG. 9 depicts a main process flow. The control unit 801 starts the camera process (S901). In the embodiment, a camera process (A) is started. In this example, the camera process is performed in parallel with the main process.

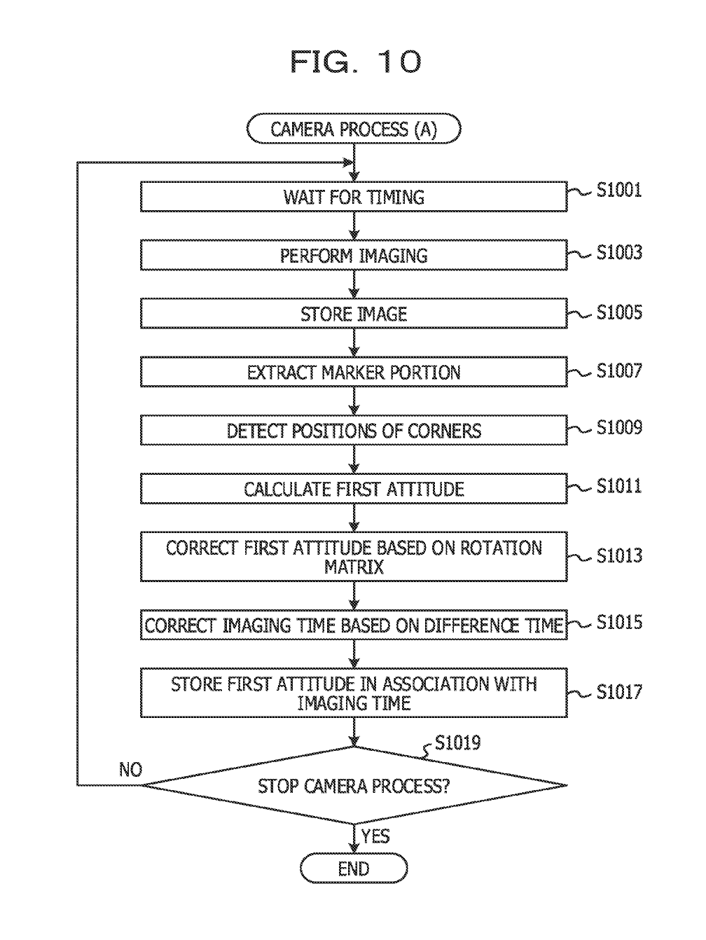

FIG. 10 depicts a camera process flow (A). The imaging unit 803 waits for an imaging timing (S1001). In this example, imaging is performed periodically,

When the certain timing comes, the imaging unit 803 performs imaging with the camera 107 (S1003). The imaging unit 803 stores the captured image in the image storage unit 831 (S1005).

The attitude estimation unit 805 extracts a portion of the image stored in the image storage unit 831 which corresponds to the marker 301 (S1007). The attitude estimation unit 805 detects positions of corners of the marker 301 based on contour lines of the portion corresponding to the marker 301 (S1009). The attitude estimation unit 805 calculates the first attitude based on the positions of the corners (S1011). Specifically, the first attitude is determined by using a pitch angle, a roll angle, and a yaw angle.

The first correction unit 823 corrects the first attitude based on the rotation matrix (S1013). Specifically, the first correction unit 823 converts the first attitude by using the rotation matrix. The converted attitude is the corrected first attitude. Note that the rotation matrix is obtained by a first calculation process to be described later and is updated every time the rotation matrix is obtained. In the conversion using an initial rotation matrix, the first attitude does not change.

The second correction unit 825 corrects the imaging time based on the difference time (S1015). Specifically, the second correction unit 825 subtracts the difference time from the imaging time corresponding to the timing of S1001. The time obtained by subtracting the difference time is the corrected imaging time. Note that the difference time is obtained by a second calculation process to be described later and is updated every time the difference time is obtained. An initial difference time is 0.

The first correction unit 823 stores the corrected first attitude in the first attitude storage unit 833 in association with the corrected imaging time (S1017).

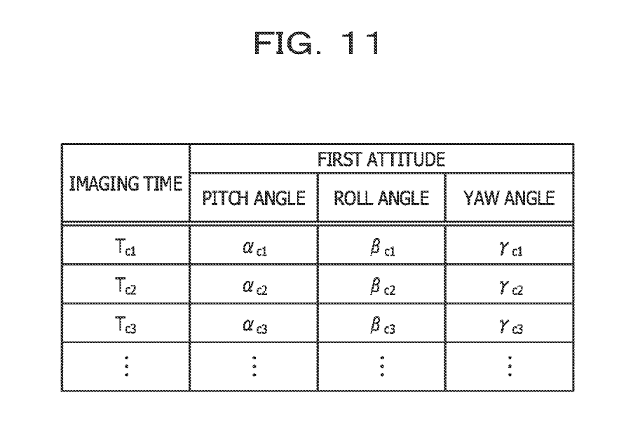

FIG. 11 depicts a configuration example of a first attitude table. The first attitude table includes records corresponding to the imaging times. Each of the records includes a field for setting the imaging time, a field for setting the pitch angle, a field for setting the roll angle, and a field for setting the yaw angle.

In this example, the pitch angle, the roll angle, and the yaw angle determine the first attitude at each imaging time. In this example, the pitch angle is an angle about the X-axis, the roll angle is an angle about the Y-axis, and the yaw angle is an angle about the Z-axis. Note that the X-axis, the Y-axis, and the Z-axis which are references are assumed to be set before the start of the camera process.

Returning to the explanation of FIG. 10, the imaging unit 803 determines whether to stop the camera process (S1019). Specifically, the imaging unit 803 determines whether to stop the camera process in S919 of the main process depicted in FIG. 9. When the imaging unit 803 determines not to stop the camera process, the flow returns to the process described in 51001 and the aforementioned processes are repeated. Meanwhile, when the imaging unit 803 determines to stop the camera process, the camera process (A) is terminated.

Returning to the explanation of FIG. 9, when the camera process is started, the flow proceeds to a process described in S903 of FIG. 9. The control unit 801 starts the inertial sensor process (S903). In the embodiment, an inertial sensor process (A) is started. In this example, the inertial sensor process is performed in parallel with the main process.

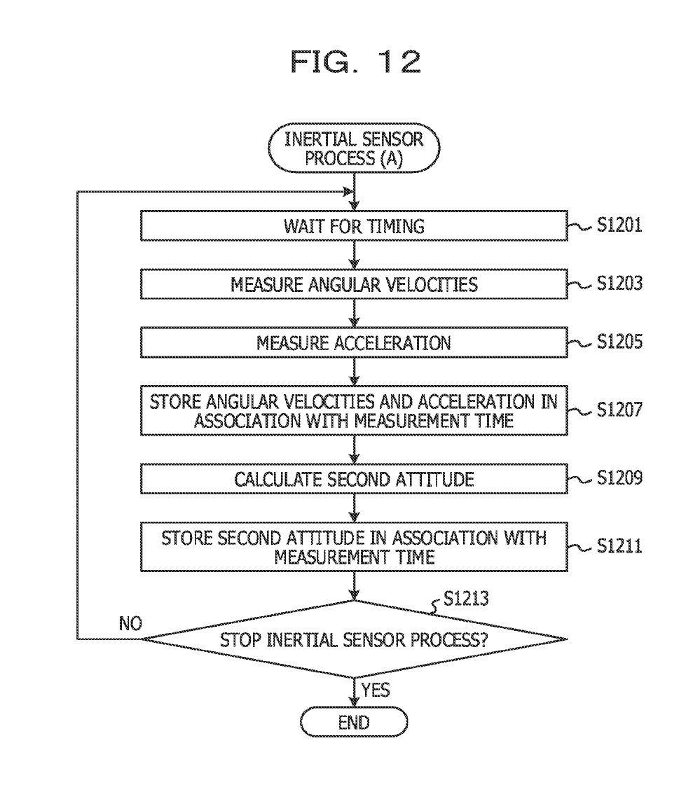

FIG. 12 depicts an inertial sensor process (A) flow. The measurement unit 807 waits for a timing (S1201). As in the camera process, the measurement is performed periodically. In this example, the measurement is performed at the same time as the imaging time in the camera process. However, the measurement may be performed at a time different from the imaging time.

The measurement unit 807 measures angular velocities by using the inertial sensor 113 (S1203). Furthermore, the measurement unit 807 measures acceleration by using the inertial sensor 113 (S1205). Then, the measurement unit 807 stores the angular velocities and the acceleration in the measurement data storage unit 835 in association with the measurement time (S1207).

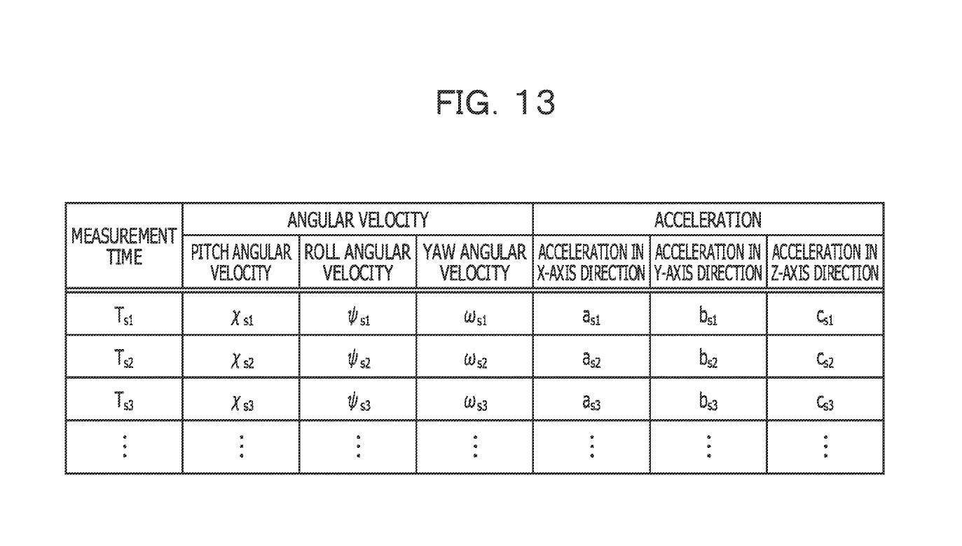

FIG. 13 depicts a configuration example of the measurement data. The measurement data in this example is in a form of a table. The measurement data includes records corresponding to the measurement times. Each of the records includes a field for setting the measurement time, a field for setting a pitch angular velocity, a field for setting a roll angular velocity, a field for setting a yaw angular velocity, a field for setting acceleration in the X-axis direction, a field for setting acceleration in the Y-axis direction, and a field for setting acceleration in the Z-axis direction.

In this example, three types of angular velocities are measured. Similarly, three types of acceleration are measured. Also in the measurement data, the pitch angle is the angle about the X-axis, the roll angle is the angle about the Y-axis, and the yaw angle is the angle about the Z-axis. Note that the X-axis, the Y-axis, and the Z-axis which are references are assumed to be set before the start of the inertial sensor process.

Returning to the explanation of FIG. 12, the attitude determination unit 809 integrates the angular velocities to obtain the second attitude (S1209). In this example, the second attitude is determined by using the pitch angle, the roll angle, and the yaw angle. In this example, the directions of the respective axes in the coordinate system on which the second attitude is based are assumed to be aligned with the directions of the respective axes in the coordinate system on which the first attitude is based. The original point of the coordinate system on which the second attitude is based may not be aligned with the original point of the coordinate system on which the first attitude is based. However, the original point of the coordinate system on which the second attitude is based may be aligned with the original point of the coordinate system on which the first attitude is based.

Then, the attitude determination unit 809 stores the second attitude in the second attitude storage unit 837 in association with the measurement time (S1211).

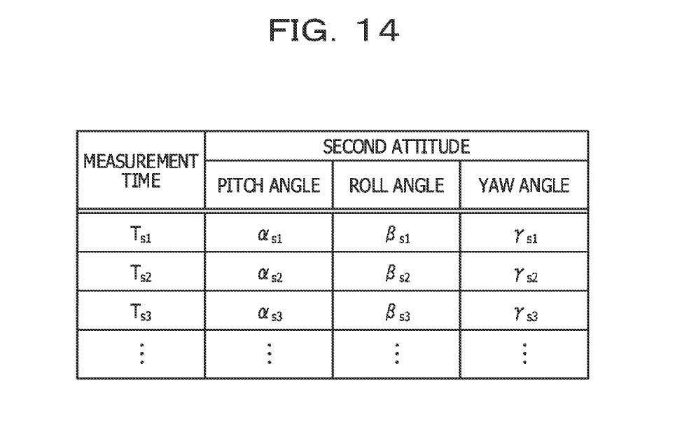

FIG. 14 depicts a configuration example of a second attitude table. The second attitude table includes records corresponding to the measurement times. Each of the records includes a field for setting the measurement time, a field for setting the pitch angle, a field for setting the roll angle, and a field for setting the yaw angle.

Returning to the explanation of FIG. 12, the measurement unit 807 determines whether to stop the inertial sensor process (S1213). Specifically, the measurement unit 807 determines whether to stop the inertial sensor process in S921 of the main process depicted in FIG. 9. When the measurement unit 807 determines not to stop the inertial sensor process, the flow returns to the process described in S1201 and the aforementioned processes are repeated. Meanwhile, when the measurement unit 807 determines to stop the inertial sensor process, the inertial sensor process (A) is terminated.

Returning to the explanation of FIG. 9, the first period determination unit 811 executes a first determination process (S905). In the first determination process, the first period determination unit 811 determines the stationary period by using the measurement time slot.

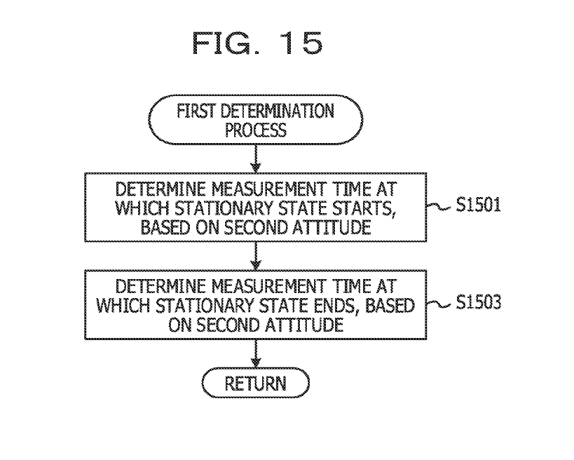

FIG. 15 depicts a first determination process flow. The first period determination unit 811 determines the measurement time at which the stationary state starts, based on the second attitude (S1501). For example, the first period determination unit 811 determines that the mobile device 101 is in the stationary state when the change of the pitch angle, the change of the roll angle, and the change of the yaw angle fall below a threshold. Meanwhile, the first period determination unit 811 determines that the mobile device 101 is not in the stationary state when the change of the pitch angle, the change of the roll angle, or the change of the yaw angle exceeds the threshold.

The first period determination unit 811 may determine the measurement time at which the stationary state starts, based on the angular velocities. For example, the first period determination unit 811 determines that the mobile device 101 is in the stationary state when the pitch angular velocity, the roll angular velocity, and the yaw angular velocity fall below a threshold. Meanwhile, the first period determination unit 811 determines that the mobile device 101 is not in the stationary state when the pitch angular velocity, the roll angular velocity, or the yaw angular velocity exceeds the threshold.

The first period determination unit 811 may determine the measurement time at which the stationary state starts, based on the acceleration. For example, the first period determination unit 811 separates a gravity component included in the acceleration and a component other than the gravity from each other, and calculates a simple moving average of the component other than the gravity. Then, the first period determination unit 811 determines that the mobile device 101 is in the stationary state when the simple moving average falls below a threshold. Meanwhile, the first period determination unit 811 determines that the mobile device 101 is not in the stationary state when the simple moving average does not fall below the threshold.

The first period determination unit 811 may determine the measurement time at which the stationary state starts, based on the second attitude and the acceleration. Specifically, the first period determination unit 811 may determine that the mobile device 101 is in the stationary state when the stationary condition of the second attitude and the stationary condition of the acceleration are both satisfied.

The first period determination unit 811 may determine the measurement time at which the stationary state starts, based on the angular velocities and acceleration. Specifically, the first period determination unit 811 may determine that the mobile device 101 is in the stationary state when the stationary condition of the angular velocities and the stationary condition of the acceleration are both satisfied,

The first period determination unit 811 determines the measurement time at which the stationary state ends, based on the second attitude, by determining whether the mobile device 101 is in the stationary state as in S1501 (S1503). The first period determination unit 811 may similarly determine the measurement time at which the stationary state ends, based on the angular velocities. The first period determination unit 811 may similarly determine the measurement time at which the stationary state ends, based on the acceleration. The first period determination unit 811 may similarly determine the measurement time at which the stationary state ends, based on the second attitude and the acceleration. The first period determination unit 811 may similarly determine the measurement time at which the stationary state ends, based on the angular velocities and the acceleration. After the first determination process is completed, the flow returns to the main process depicted in FIG. 9,

Returning to the explanation of FIG. 9, the first calculation unit 813 executes a first calculation process (S907). In the first calculation process, the first calculation unit 813 calculates the rotation matrix used to perform the conversion of approximating the camera coordinate system to the sensor coordinate system.

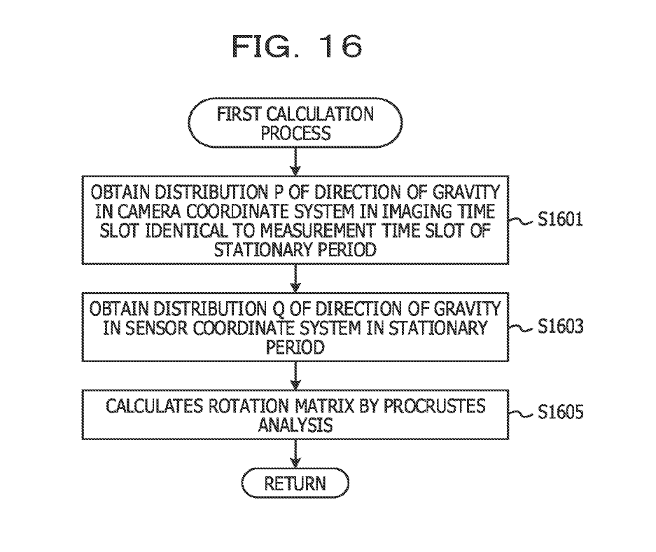

FIG. 16 depicts a first calculation process flow. The first calculation unit 813 obtains distribution P {pᵢ, i=1 to n} of the vectors in the direction of gravity in the camera coordinate system, for samples included in the imaging time slot identical to the measurement time slot for determining the stationary period (S1601). The distribution P of the vectors in the direction of gravity in the camera coordinate system is stored in the first distribution storage unit 839. The imaging time slot identical to the measurement time slot means that the values of times indicating the respective time slots are the same, and does not mean that both time slots are substantially simultaneous.

The first calculation unit 813 obtains distribution Q {qᵢ, i=1 to n} of the vectors in the direction of gravity in the sensor coordinate system, for samples included in the measurement time slot for determining the stationary period (S1603). The distribution Q of the vectors in the direction of gravity in the sensor coordinate system is stored in the second distribution storage unit 841.

The first calculation unit 813 calculates the rotation matrix by Procrustes analysis (S1605). In the Procrustes analysis, the rotation matrix used to perform the conversion of approximating the camera coordinate system to the sensor coordinate system is obtained with the vectors in the direction of gravity being the reference. The Procrustes analysis is a conventional technique. The Procrustes analysis in the embodiment is briefly described below.

First, the first calculation unit 813 obtains an average pₐ of the vectors in the direction of gravity in the camera coordinate system. Then, the first calculation unit 813 obtains an average qₐ of the vectors in the direction of gravity in the sensor coordinate system.

Then, the first calculation unit 813 obtains vector A=[p₁-pₐ, . . . , p₁-pₐ] based on a difference between the average pₐ and each vector pᵢ in the direction of gravity in the camera coordinate system. Furthermore, the first calculation unit 813 obtains vector B=[q₁-qₐ, . . . , q₁-qₐ] based on a difference between the average qₐ and each vector qᵢ in the direction of gravity in the sensor coordinate system.

Next, the first calculation unit 813 performs single-value decomposition expressed by the formula “USV_{T}=C” for vector C=BA_{T}. Then, the first calculation unit 813 obtains a rotation matrix R according to the formula “R=U diag(1, 1, det(UV_{T}))Vₜ”. The rotation matrix R is stored in the rotation matrix storage unit 843. When the first calculation process is completed, the flow returns to the main process described in FIG. 9.

Returning to the explanation of FIG. 9, the second period determination unit 815 executes a second determination process (S909). In the second determination process, the second period determination unit 815 determines the rotation period by using the measurement time slot.

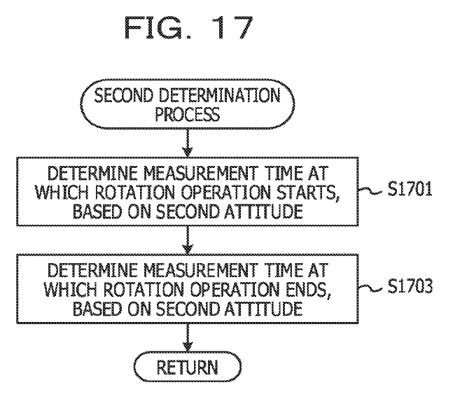

FIG. 17 depicts a second determination process flow. The second period determination unit 815 determines the measurement time at which the rotation operation starts, based on the second attitude (S1701). For example, the second period determination unit 815 determines that the mobile device 101 is in the rotation state when a change amount of the pitch angle and the change amount of the roll angle in a predetermined interval fall below a first threshold and a change amount of the yaw angle in the same interval exceeds a second threshold. Meanwhile, the second period determination unit 815 determines that the mobile device 101 is not in the rotation state when the change amount of the pitch angle and the change amount of the roll angle in a certain interval exceed the first threshold. The second period determination unit 815 also determines that the mobile device 101 is not in the rotation state when the change amount of the yaw angle in the same interval falls below the second threshold.

The second period determination unit 815 may determine the measurement time at which the rotation state starts, based on the angular velocities. For example, the second period determination unit 815 determines that the mobile device 101 is in the rotation state when the angular velocity of the pitch angle and the angular velocity of the roll angle in a certain interval fall below a third threshold and the angular velocity of the yaw angle in the same interval exceeds a fourth threshold. Meanwhile, the second period determination unit 815 determines that the mobile device 101 is not in the rotation state when the angular velocity of the pitch angle and the angular velocity of the roll angle in a certain interval exceeds the third threshold. The second period determination unit 815 also determines that the mobile device 101 is not in the rotation state when the angular velocity of the yaw angle in the same interval falls below the fourth threshold,

The second period determination unit 815 determines the measurement time at which the rotation operation ends, based on the second attitude, by determining whether the mobile device 101 is in the rotation state as in S1701 (S1703). The second period determination unit 815 may similarly determine the measurement time at which the rotation state ends, based on the angular velocities. When the second determination process is completed, the flow returns to the main process depicted in FIG. 9.

Returning to the explanation of FIG. 9, the second calculation unit 817 executes a second calculation process (S911). In the second calculation process, the second calculation unit 817 calculates the difference time between the imaging time and the measurement time.

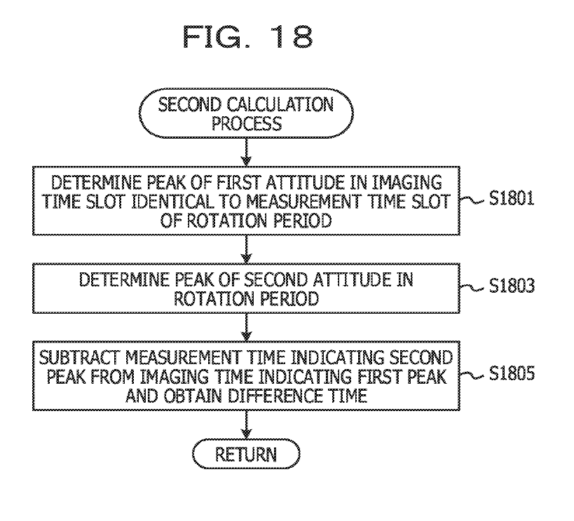

FIG. 18 depicts a second calculation process flow. In this example, peaks are set as characteristic points and there is obtained a difference between the imaging time at which the characteristic point appears and the measurement time at which the characteristic point appears. The second calculation unit 817 determines a peak of the first attitude (referred to as first peak) in the imaging time slot identical to the measurement time slot for determining the rotation period (S1801). The second calculation unit 817 determines a peak of the second attitude (referred to as second peak) in the rotation period (S1803). The second calculation unit 817 subtracts the measurement time of the second peak from the imaging time of the first peak and obtains the difference time (S1805). The difference time is stored in the difference time storage unit 845.

When there are multiple peaks, it is possible to obtain a difference time for each pair of corresponding peaks and obtain the average of the difference time. Moreover, the difference time may be obtained based on characteristic points other than the peaks.

Alternatively, the difference time may be obtained by determining a shift amount by which a degree of similarity between a waveform indicating a change of the first attitude in the imaging time slot and a waveform indicating a change of the second attitude in the measurement time slot increases. Since processes of mutual-correlation analysis for obtaining the degree of similarly between the waveforms are a conventional technique, further description is omitted. When the second calculation process is completed, the flow returns to the main process depicted in FIG. 9.

Returning to the explanation of FIG. 9, the judgment unit 819 executes a judgment process (S913). In the judgment process, the judgment unit 819 judges whether a stable state is achieved. The stable state herein refers to a state where the rotation matrix and the difference time are converged.

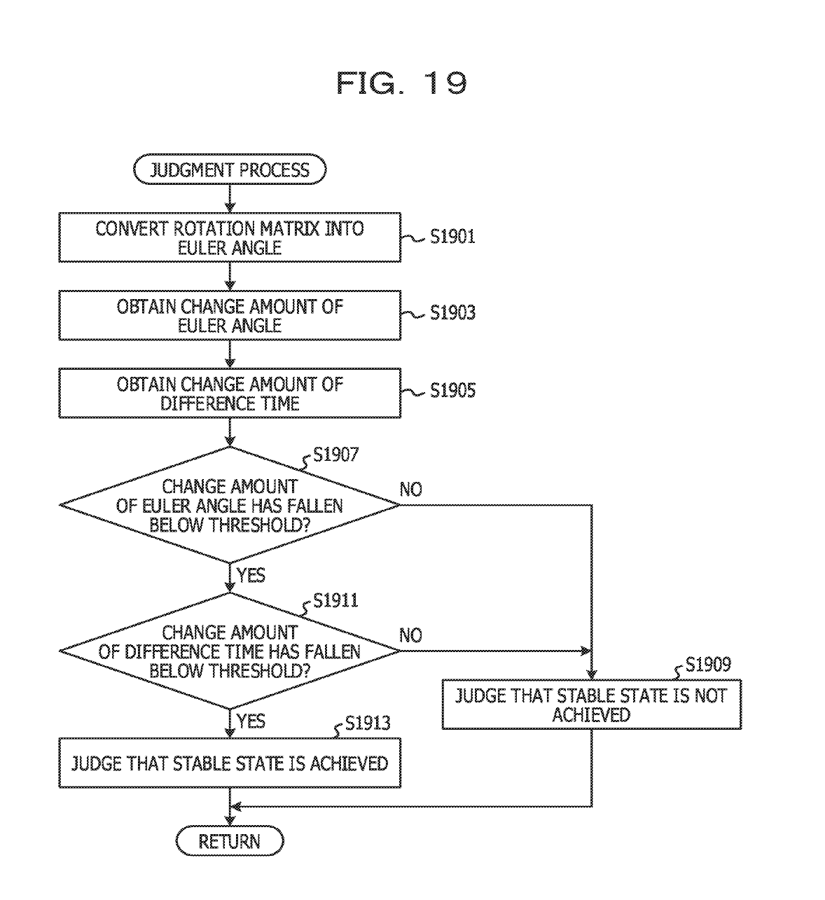

FIG. 19 depicts a judgment process flow. The judgment unit 819 converts the rotation matrix into an Euler angle (S1901). The judgment unit 819 obtains a change amount of the Euler angle (S1903). Specifically, the judgment unit 819 calculates a difference between the Euler angle obtained in the process of S1901 performed this time and the Euler angle obtained in the process of S1901 performed last time.

The judgment unit 819 obtains a change amount of the difference time (S1905). Specifically, the judgment unit 819 calculates a difference between the difference time obtained in the second calculation process performed this time and the difference time obtained in the second calculation process performed last time.

The judgment unit 819 determines whether the change amount of the Euler angle has fallen below a threshold (S1907). When determining that the change amount of the Euler angle has not fallen below the threshold, the judgment unit 819 judges that the stable state is not achieved (S1909).

Meanwhile, when determining that the change amount of the Euler angle has fallen below the threshold, the judgment unit 819 then determines whether the change amount of the difference time has fallen below a threshold (S1911). When determining that the change amount of the difference time has not fallen below the threshold, the judgment unit 819 judges that the stable state is not achieved (S1909).

Meanwhile, when determining that the change amount of the difference time has fallen below the threshold, the judgment unit 819 judges that the stable state is achieved (S1913). When the judgment process is completed, the flow returns to the main process depicted in FIG. 9.

Returning to the explanation of FIG. 9, the control unit 801 causes the process to branch depending on a result of the judgment process (S915), When the judgment unit 819 judges that the stable state is not achieved, the flow returns to the process described in S905 and the aforementioned processes are repeated.

Meanwhile, when the judgment unit 819 judges that the stable state is achieved, the output unit 821 outputs a signal indicating the completion of the adjustment (S917). For example, the output unit 821 outputs a predetermined sound to notify the completion of the adjustment. The output unit 821 may display a completion message.

Lastly, the control unit 801 stops the camera process (S919) and also stops the inertial sensor process (S921). Note that the rotation matrix and the difference time used in following processes are stored. Note that the control unit 801 may not stop the camera process to prepare for use of the camera 107. Moreover, the control unit 801 may not stop the inertial sensor process to prepare for use of the inertial sensor 113.

The rotation matrix in this example is one mode of expressing an error between the attitude of the camera 107 and the attitude of the inertial sensor 113. The error between the attitude of the camera 107 and the attitude of the inertial sensor 113 may be expressed in a different mode. For example, the error between the attitude of the camera 107 and the attitude of the inertial sensor 113 may be expressed by an Euler angle.

In the embodiment, it is possible to efficiently reduce the time error and the attitude error of the camera 107 and the inertial sensor 113 which are included in the mobile device 101.

Moreover, since the direction of gravity is used as the reference, it is possible to grasp the relationships between the attitude of the camera and the attitude of the sensor more correctly.

Furthermore, since the processes described in S905 to S911 are repeated, the time error and the attitude error may be further reduced,

Moreover, since the aforementioned repeating of the processes is terminated when the time error and the attitude error are judged to be converged, it is possible to omit processes which are less effective.

Since the calibration is performed in this example such that the first attitude is aligned with the second attitude and the imaging time is aligned with the measurement time, the example is suitable for usage based on the inertial sensor 113.

### Embodiment 2

In the embodiment described above, description is given of the example in which the first attitude is aligned with the second attitude and the imaging time is aligned with the measurement time. Meanwhile, in this embodiment, description is given of an example in which the second attitude is aligned with the first attitude and the measurement time is aligned with the imaging time,

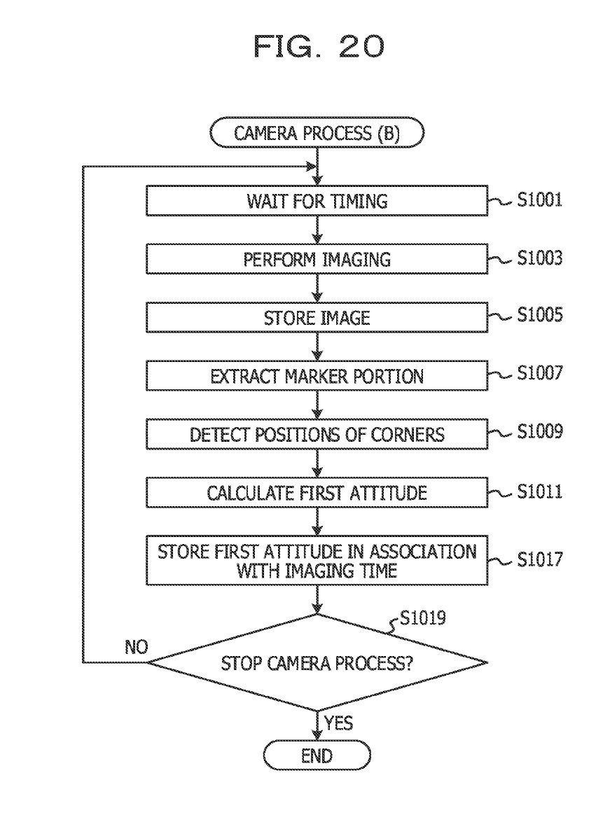

In the embodiment, a camera process (B) is executed instead of the camera process (A). FIG. 20 depicts a camera process (B) flow. Processes described in S1001 to S1011 are the same as those in the camera process (A).

The process described in S1013 and the process described in S1015 in the camera process (A) are omitted. In S1017, the first attitude calculated in S1011 is stored instead of the corrected first attitude,

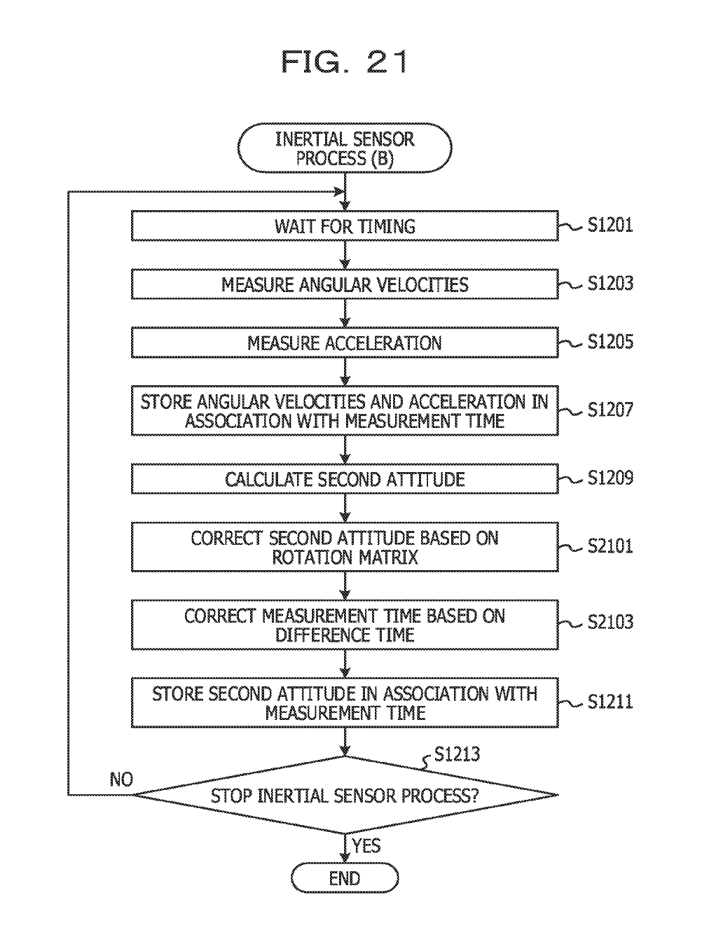

Moreover, in the embodiment, an inertial sensor process (B) is executed instead of the inertial sensor process (A). FIG. 21 depicts an inertial sensor process (B) flow. Processes described in S1201 to S1209 are the same as those in the inertial sensor process (A).

The first correction unit 823 corrects the second attitude based on a rotation matrix (S2101). Specifically, the first correction unit 823 converts the second attitude by using the rotation matrix. The converted attitude is a corrected second attitude. The rotation matrix in the embodiment is an inverse matrix of the rotation matrix in Embodiment 1.

Specifically, in a first calculation process in the embodiment, the first calculation unit 813 calculates a rotation matrix used to perform conversion of approximating the sensor coordinate system to the camera coordinate system. To be more specific, in the process described in S1605 of FIG. 16, the first calculation unit 813 obtains the rotation matrix by interchanging the distribution P of the vectors in the direction of gravity in the camera coordinate system and the distribution Q of the vectors in the direction of gravity in the sensor coordinate system.

The second correction unit 825 corrects the measurement time based on the difference time (S2103). Specifically, the second correction unit 825 adds the difference time to the imaging time corresponding to the timing of S1201. The time to which the difference time is added is the corrected measurement time.

In S1211, the first correction unit 823 stores the corrected second attitude in the first attitude storage unit 833 in association with the corrected measurement time.

Since the calibration is performed such that the second attitude is aligned with the first attitude and the measurement time is aligned with the imaging time in the embodiment, the embodiment is suitable for usage based on the camera 107.

In the examples described above, the first attitude is estimated by using the marker. A technique of estimating the attitude by imaging the marker 301 with the camera 107 as described above is disclosed in Hirokazu Kato et al, “An Augmented Reality System and its Calibration based on Marker Tracking”, TVRSJ, Vol. 4 No. 4, 1999.

Moreover, techniques of estimating the attitude based on characteristic points in any imaging target without using a predetermined figure are disclosed in Yoko Ogawa et al., “A Method of Selecting Delegate Landmarks for Fast Localization and Robot Navigation Using Monocular Vision”, Journal of Robotic Society of Japan, 29 (9), P811-820, Nov. 15, 2011 and G. Klein et al., “Parallel Tracking and Mapping for Small AR Workspace (PTAM)”, ISMAR, 2007. In the embodiment, the first attitude may be estimated by using these techniques.

Moreover, in the examples described above, the error between the time measured by the first real-time clock 111 and the time measured by the second real-time clock 117 is obtained. However, in addition to the difference between the times, a difference between the speed of time count in the first real-time clock 111 and the speed of time count in the second real-time clock 117 may be obtained.

Although the embodiments have been described above, the present disclosure is not limited by the embodiments. For example, the aforementioned functional block configuration sometimes does not match the program module configuration.

Moreover, the configuration of the storage regions described above is merely an example, and the configuration of the storage regions does not have to be like one described above. Furthermore, in the process flows, it is possible to change the order of processes and execute multiple processes in parallel, as long as the process results do not change.

The embodiments described above are summarized as follows,

A correction method of one aspect is a correction method in an electronic device including a camera, a first clock used to determine an imaging time of the camera, a sensor configured to measure a parameter for determining an attitude of the sensor itself, and a second clock used to determine a measurement time of the sensor, the correction method including: (A) repeatedly performing imaging with the camera; (B) estimating an attitude of the camera based on captured images; (C) repeatedly measuring the parameter with the sensor; (D) determining an attitude of the sensor based on the aforementioned measured parameter; (E) performing a first process of calculating a rotation parameter indicating a difference between the attitude of the camera and the attitude of the sensor, based on the attitude of the sensor in a first measurement time slot in which the attitude of the sensor is stable and the attitude of the camera in a first imaging time slot identical to the first measurement time slot; (F) performing a second process of correcting at least one of data indicating the attitude of the camera and data indicating the attitude of the sensor, based on the rotation parameter; (G) performing a third process of calculating a difference time between a first time measured by the first clock and a second time measured by the second clock, based on the attitude of the sensor in a second measurement time slot in which the attitude of the sensor is changing and the attitude of the camera in a second imaging time slot identical to the second measurement time slot; and (H) performing a fourth process of correcting at least one of the imaging time and the measurement time, based on the difference time.

This may efficiency reduce the time error and the attitude error of the camera and the sensor configured to determine the attitude which are included in the same electronic device. Specifically, this facilitates solving of a problem that the attitude error may not be correctly determined unless the time error is reduced and the time error may not be correctly determined unless the attitude error is reduced. In other words, by correcting both errors instead of reducing one of the errors by focusing on the one error, it is possible to improve the correction accuracy of both errors and complete the adjustment more quickly.

Furthermore, in the performing the first process described above, the rotation parameter may be calculated based on the direction of gravity.

This facilitates correct grasping of relationships between the attitude of the camera and the attitude of the sensor.

Moreover, the correction method may include repeating the performing the first process to the performing the fourth process.

This may further reduce the time error and the attitude error.

Furthermore, the correction method may include a process of judging whether the rotation parameter and the difference time are converged according to a predetermined standard, and the performing the first process to the performing the fourth process may be terminated when the rotation parameter and the difference time are judged to be converged.

Less effective processes may be thereby omitted.

Note that a program for causing a processor to perform the processes described above may be created. The program may be stored in a computer readable storage medium or storage device such as, for example, a flexible disk, a CD-ROM, a magnetic-optical disc, a semiconductor memory, and a hard disk. Note that intermediate process results are generally temporarily stored in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a camera configured to capture a plurality of images according to an imaging time based on a first clock;
a sensor configured to measure a parameter for determining an attitude of the sensor according to a measurement time based on a second clock; and
circuitry configured to:
determine an attitude of the camera based on the plurality of images captured by the camera,
determine an attitude of the sensor based on a plurality of pararmeters measured by the sensor,
first calculate a rotation parameter indicating a difference between the attitude of the camera and the attitude of the sensor based on the attitude of the sensor and the attitude of the camera in a first measurement time period during which the attitude of the electronic device is in a stable state,
first correct at least one of data indicating the attitude of the camera and data indicating the attitude of the sensor based on the rotation parameter,
second calculate a time difference between a first time measured by the first clock and a second time measured by the second clock based on the attitude of the camera and the attitude of the sensor in a second measurement time period, and
second correct at least one of the imaging time and the measurement time based on the time difference.

2. The electronic device of claim 1, wherein the second measurement time period is a time period during which the attitude of the electronic device is determined to be changing,

3. The electronic device of claim 1, wherein the rotation parameter indicates a difference between a coordinate system of the camera and a coordinate system of the sensor.

4. The electronic device of claim 3, wherein the circuitry is configured to perform the first correction by applying the rotation parameter to at least one of the coordinate system of the camera and the coordinate system of the sensor.

5. The electronic device of claim 3, wherein the rotation parameter is calculated based on a first direction of gravity in the coordinate system of the camera and a second direction of gravity in the coordinate system of the sensor.

6. The electronic device of claim 5, wherein the rotation parameter is generated based on a distribution of the first direction of gravity during the first measurement time period and a distribution of the second direction of gravity during the second measurement time period.

7. The electronic device of claim 1, wherein the time difference is calculated based on a difference between a sine wave indicating a change over time of the attitude of the camera and a sine wave indicating a change over time of the attitude of the sensor.

8. The electronic device of claim 1, wherein the circuitry is configured to perform the first calculating, the first correcting, the second calculating and the second correcting iteratively until it is determined that the rotation parameter and the time difference are converged.

9. The electronic device of claim 8, wherein the circuitry is configured to:
determine whether the rotation parameter and the time difference are converged according to a predetermined standard; and
terminate iteratively performing the first calculating, the first correcting, the second calculating and the second correcting when the rotation parameter and the time difference are determined to be converged.

10. The electronic device of claim 9, wherein the circuitry is configured to:
generate firs correction information to be set on one of the first clock and the second clock based on the time difference when the rotation parameter and the time difference are determined to be converged, and
generate second correction information to be set on one of the camera and the sensor based on the rotation parameter.

11. The electronic device of claim 1, wherein the circuitry is configured to:
detect a reference object in the plurality of Images captured by the camera at a plurality of imaging times; and
determine attitudes of the camera at each of the plurality of imaging times based on the reference object detected in each of the plurality of images.

12. An electronic device comprising:
a camera configured to capture an image including a reference object according to an imaging time based on a first clock, the imaging time including a plurality of first times;
an inertial sensor configured to perform measurement in simultaneously with the imaging by the camera according to a measurement time based on a second clock, the measurement time including a plurality of second times; and
circuitry configured to:
detect the reference object in each of a plurality of images captured by the camera at the plurality of first times,
determine first attitudes of the camera at each of the plurality of first times based the reference object detected in each of the plurality of images,
store the plurality of first times and the first attitudes in a memory,
determine second attitudes of the inertial sensor at each of the plurality of second times based on a plurality of measurement results measured by the inertial sensor at each of the plurality of second times,
store the plurality of second times and the second attitudes in the memory,
execute a first process of generating first correction information indicating a first difference between a camera coordinate system for the camera and a sensor coordinate system for the inertial sensor, and
execute a second process of generating second correction information indicating a time difference between the first clock and the second clock, and
wherein the first process includes:
identifying a time period during which the electronic device is in a stable state,
generating the first correction information based on a difference between the first attitude and the second attitude during the time period, and
correcting at least one of the first attitude and the second attitude in the memory based on the first correction information, and wherein the second process includes:
generating the second correction information based on a difference in timing between a first time change of the first attitude and a second time change of the second attitude, and
correcting at least one of the plurality of first times and the plurality of second times in the memory based on the second correction information.

13. The electronic device of claim 12, wherein the circuitry is configured to iteratively perform the first process and the second process until the first correction information and newly generated first correction information converge and the second correction information and newly generated second correction information converge.

14. The electronic device of claim 13, wherein the circuitry is configured to correct at least one of the camera coordinate system or the sensor coordinate system based on the newly generated first correction information and correct at least one of the first dock or the second clock based on the newly generated second correction information when the first correction information and the newly generated first correction information are determined to be converged and the second correction information and the newly generated second correction information are determined to be converged.

15. The electronic device of claim 12, wherein the first correction information is a rotation parameter of one of the camera coordinate system and the sensor coordinate system based on another one of the camera coordinate system and the sensor coordinate system.

16. The electronic device of claim 15, wherein the rotation parameter is generated based on a first direction of gravity in the camera coordinate system and a second direction of gravity in the sensor coordinate system.

17. The electronic device of claim 16, wherein the rotation parameter is generated based on a distribution of the first direction of gravity at the plurality of first times and a distribution of the second direction of gravity at the plurality of second times.

18. The electronic device of claim 12, wherein the second correction information is generated based on a difference between a sine wave indicating a time change of the first attitude and a sine wave indicating a time change of the second attitude during a time period in which the camera or the inertial sensor is rotated.

19. The electronic device of claim 12, wherein the period of the stable state is determined from the first time change of the first attitude and or the second time change of the second attitude.

20. A correction method executed by circuitry of an electronic device including a camera capturing a plurality of images according to an imaging time based on a first dock, and a sensor measuring a parameter for determining an attitude of the sensor according to a measurement time based on a second clock, the method comprising:
determining an attitude of the camera based on a plurality of images captured by the camera;
determining an attitude of the sensor based on a plurality of parameters measured by the sensor;
first calculating a rotation parameter indicating a difference between the attitude of the camera and the attitude of the sensor based on the attitude of the sensor and the attitude of the camera in a first measurement time period during which the attitude of the electronic device is in a stable state;
first correcting at least one of data indicating the attitude of the camera and data indicating the attitude of the sensor based on the rotation parameter;
second calculating a time difference between a first time measured by the first clock and a second time measured by the second clock based on the attitude of the camera and the attitude of the sensor in a second measurement time period; and
second correcting at least one of the imaging time and the measurement time based on the time difference.
